(19) United States
(12) Patent Application Publication
(10) Pub. No.: US 2026/0117084 A1
(43) Pub. Date: Apr. 30, 2026

(54) ACTIVE RAY CURABLE INKJET INK AND METHOD FOR PRODUCING PRINTED MATERIAL USING THE SAME

(71) Applicant: Konica Minolta, Inc., Tokyo (JP)

(72) Inventors: Hidekazu KAWASAKI, Tokyo (JP); Kouichi SUGAMA, Tokyo (JP)

(21) Appl. No.: 19/352,624

(22) Filed: Oct. 8, 2025

(30) Foreign Application Priority Data
Oct. 29, 2024 (JP) 2024-189703

(51) Int. Cl. C09D 11/38; B41J 11/00; C08K 5/101; C08K 5/3435; C08K 5/5397; C09D 11/322

(52) U.S. Cl. CPC C09D 11/38; B41J 11/0021; C08K 5/101; C08K 5/3435; C08K 5/5397; C09D 11/322

(57) ABSTRACT

An object of the present invention is to provide an active ray curable inkjet ink that is less likely to cause satellites and mist during printing and can form a coating film having satisfactory post-processability. An active ray curable inkjet ink that achieves the above-described object contains a photopolymerizable compound, a photoinitiator, a gelling agent, a pigment, and a pigment-dispersing agent. In addition, the active ray curable inkjet ink further contains a compound represented by a specific structural formula, and the amount of the photopolymerizable compound is 70% by mass or more with respect to the total mass of the active ray curable inkjet ink.

### CROSS REFERENCE TO RELATED APPLICATIONS

Japanese Patent Application No. 2024-189703 filed on Oct. 29, 2024, including description, claims, and abstract the entire disclosure is incorporated herein by reference in its entirety.

### BACKGROUND

### Technological Field

The present invention relates to an active ray curable inkjet ink and a method for producing a printed material using the same.

### Description of Related Art

Image formation by an inkjet method is used in various printing fields because image formation by the inkjet method can be performed easily and inexpensively. One of the image forming methods is a method in which droplets of an active ray curable inkjet ink are landed on a recording medium and then cured by irradiation with active rays. According to the method, it is possible to form an image even on a recording medium having no ink absorbency. Active ray curable inkjet ink generally contains a photopolymerizable compound, a polymerization initiator, and a color material such as a pigment (e.g., Japanese Unexamined Patent Publication No. 2014-156506).

When ink droplets are ejected from an inkjet nozzle of an inkjet apparatus, pressure is applied to the ink droplets or charging is applied to the ink droplets. As a result, some of the ink droplets split apart, causing phenomena called satellites and mist. A satellite refers to an unintended ink droplet that has split from a main droplet of ink, and a printing failure occurs when the satellite lands on a recording medium. In addition, mist refers to ink droplets having a significantly smaller diameter than satellites, and the mist leads to contamination of inkjet nozzles and surrounding devices.

In order to reduce the satellites and the mist, attempts have been made to lower the viscosity of the ink and to reduce the surface tension of the ink. However, in such an adjustment method, an inkjet ink is less likely to be formed into droplets, which causes a problem such that printing becomes difficult or an image having a desired quality is less likely to be obtained.

On the other hand, it is required to perform various post-processing, such as varnish coating, on a printed material obtained by printing an active ray curable ink. However, as described above, when the viscosity of an ink is reduced or the surface tension of the ink is adjusted, the surface of the cured product thereof tends to repel varnish or the like for post-processing, which has led to the problem that conventional printed materials have low post-processability.

### SUMMARY

The present invention has been made in view of the above-mentioned circumstances. An object of an aspect of the present invention is to provide an active ray curable inkjet ink that is less likely to cause satellites and mist during printing and can form a coating film having satisfactory post-processability, and a method for producing a printed material using the same.

An aspect of the present invention for achieving the object provides an active ray curable inkjet ink including a photopolymerizable compound, a photoinitiator, a pigment, and a pigment-dispersing agent, in which
the active ray curable inkjet ink further contains a compound represented by a general formula (1) below:

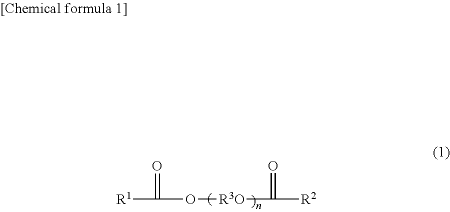

in the general formula (1),
   R¹ and R² each independently represent a substituted or unsubstituted alkyl group, a substituted or unsubstituted alkoxy group, a substituted or unsubstituted alkylthio group, a substituted or unsubstituted aryl group, a substituted or unsubstituted heterocyclic group, or a combination thereof,
   R³ represents a substituted or unsubstituted alkylene group having 2 or more and 6 or less carbon atoms, and
   n represents an integer of 50 or more and 300 or less; and
an amount of the photopolymerizable compound is 70% by mass or more with respect to a total mass of the active ray curable inkjet ink.

Furthermore, an aspect of the present invention for achieving the object provides a method for producing a printed material, the method including: ejecting an ink droplet of the active ray curable inkjet ink from an inkjet recording head to cause the ink droplet to land on a recording medium; and irradiating the ink droplet having landed on the recording medium with an active ray to cure the ink droplet.

### DETAILED DESCRIPTION OF EMBODIMENTS

Hereinafter, an embodiment of the present invention will be described in detail. However, the present invention is not limited to the following embodiment.

### 1. Active Ray Curable Inkjet Ink

The active ray curable inkjet ink of the present embodiment contains a photopolymerizable compound, a photoinitiator, a pigment, a pigment-dispersing agent, and a compound represented by the general formula (1) described below. In the present specification, the “active ray curable inkjet ink” (hereinafter, also referred to as “ink”) means an ink curable by active rays. In addition, the “active ray” means a ray capable of curing the ink by activating the photoinitiator in the ink. Examples of the active ray include α-ray, γ-ray, X-ray, ultraviolet ray, visible light, electron beam and the like. Note that the active ray for curing the ink of the present embodiment is preferably an ultraviolet ray, visible light, and an electron beam, and more preferably an ultraviolet ray or visible light, from the viewpoint of availability of an irradiation device, curability of the ink, and the like.

As described above, a conventional ink has a problem of being easily split to form satellites and mists when extruded from an inkjet head. In addition, when the viscosity or the surface tension of the ink is adjusted in order to suppress the satellite or the mist, there is a problem in that the printed material obtained from the ink has low post-processability. In contrast, since the ink of the present invention contains a compound represented by the following general formula (1) (hereinafter, also referred to as a “droplet adjusting agent”), satellites and mist are less likely to be generated, and furthermore, the post-processability of the printed material to be obtained is satisfactory.

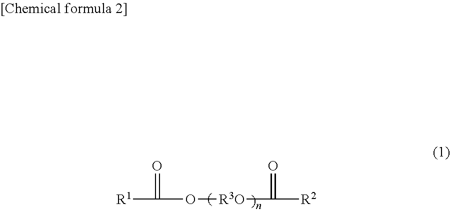

In the general formula (1), R¹ and R² each independently represent a substituted or unsubstituted alkyl group, a substituted or unsubstituted alkoxy group, a substituted or unsubstituted alkylthio group, a substituted or unsubstituted aryl group, a substituted or unsubstituted heterocyclic group, or a combination thereof, R³ represents a substituted or unsubstituted alkylene group having 2 or more and 6 or less carbon atoms, and n represents an integer of 50 or more and 300 or less.

The reason why the above-described effect is obtained by the addition of the droplet adjusting agent is not clear, but it is considered as follows. The droplet adjusting agent includes a portion having relatively high hydrophobicity (hereinafter, also referred to as a “hydrophobic moiety”) represented by R¹ and R², and a portion having high hydrophilicity (hereinafter, also referred to as a “hydrophilic moiety”) sandwiched therebetween. When the ink of the present embodiment is extruded from an inkjet head, the hydrophobic moieties of the droplet adjusting agent tend to move to the surface (gas-liquid interface) side of the droplet and align, and the droplet adjusting agent tends to cover the surface of the droplet. Further, the droplet adjusting agent has a large value of n in the general formula (1) and thus has a relatively large molecular weight. Therefore, the droplet adjusting agent having a large molecular weight is more likely to cover the entire surface of the ink droplet. Thus, even when pressure or the like is applied to the droplet, the droplet is less likely to be split, and satellites and mist are less likely to be generated. Furthermore, in the droplet adjusting agent, the chain forming the hydrophilic moiety is long and the hydrophilic moiety is large. Therefore, the hydrophilic moiety of the droplet adjusting agent is more likely to be present on the surface of the coating film (cured product of the ink), and a hydrophilic area is generated. Therefore, the affinity between the coating film and a hydrophilic liquid for post-processing becomes satisfactory, and the post-processability becomes satisfactory. Hereinafter, each component will be described.

### [Droplet Adjusting Agent]

As described above, the droplet adjusting agent is a compound represented by the following general formula (1). The ink may contain only one type of droplet adjusting agent, or may contain two or more types thereof.

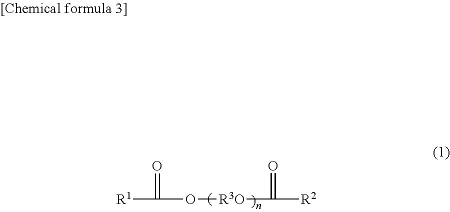

In the general formula (1), R¹ and R² each independently represent a substituted or unsubstituted alkyl group, a substituted or unsubstituted alkoxy group, a substituted or unsubstituted alkylthio group, a substituted or unsubstituted aryl group, a substituted or unsubstituted heterocyclic group, or a combination thereof.

Examples of the alkyl group, which may be R¹ and R², include linear or branched alkyl groups having 1 or more and 30 or less carbon atoms, preferably 12 or more and 22 or less carbon atoms. Furthermore, examples of the alkoxy group include linear or branched alkoxy groups having 1 or more and 30 or less carbon atoms, and preferably 12 or more and 22 or less carbon atoms. Examples of the alkylthio group include linear or branched alkylthio groups having 1 or more and 30 or less carbon atoms, and preferably 12 or more and 22 or less carbon atoms. Examples of the aryl group include phenyl group and naphthyl group, with a phenyl group being preferred. Examples of the heterocyclic group include groups derived from 5-membered rings such as furan, tetrahydrofuran, pyrrole, pyrrolidine, thiophene and imidazole, groups derived from 6-membered rings such as pyridine and pyrrolidine, and groups derived from fused rings such as quinoline and indole, with a group derived from furan being preferred. Among these, an alkyl group having 12 or more and 22 or less carbon atoms is preferable, and an unsubstituted alkyl group is particularly preferable.

In addition, examples of the substituent group which may be bonded to the above-described alkyl group, alkoxy group and alkylthio group include a halogen atom, a hydroxy group and the like. In addition, examples of the substituent group which may be bonded to the aryl group or the heterocyclic group include an alkyl group having 1 or more and 12 or less carbon atoms, an alkoxy group having 1 or more and 12 or less carbon atoms, and an alkylthio group having 1 or more and 12 or less carbon atoms. Among these, R¹ and R² are preferably an unsubstituted or substituted alkyl group having 12 or more and 22 or less carbon atoms, and particularly preferably an unsubstituted alkyl group having 12 or more and 22 or less carbon atoms.

Meanwhile, R³ in the above general formula (1) represents a substituted or unsubstituted alkylene group having from 2 or more and 6 or less carbon atoms, examples thereof include ethylene group (—CH₂CH₂—), propylene group (—CH₂CH(CH₃)—), trimethylene group (—CH₂CH₂CH₂—), tetramethylene group (—CH₂CH₂CH₂CH₂—), hexamethylene group (—CH₂CH₂CH₂CH₂CH₂CH₂—), and the like. In addition, examples of the substituent group which may be bonded to the alkylene group include a halogen atom and hydroxy.

Furthermore, in the general formula (1), n may be an integer of 50 or more and 300 or less, and is preferably 100 or more and 250 or less. Note that when the above-mentioned n is less than 50, the length of the hydrophilic moiety of the droplet adjusting agent becomes short, and the post-processability decreases. On the other hand, when n is greater than 300, an increase in viscosity occurs due to an increase in molecular weight, and the ejectability from inkjet nozzles deteriorates.

The compound represented by the general formula (1) is preferably a compound represented by the following general formula (2).

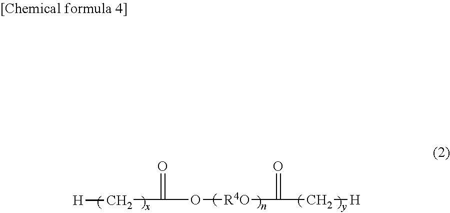

In the above-described general formula (2), R⁴ represents a substituted or unsubstituted ethylene group, a substituted or unsubstituted propylene group, a substituted or unsubstituted trimethylene group, or a substituted or unsubstituted tetramethylene group. Furthermore, x and y each independently represent an integer of 1 or more and 30 or less, and n represents an integer of 50 or more and 300 or less.

Furthermore, the compound represented by the above general formula (1) is more preferably a compound represented by the following general formula (3).

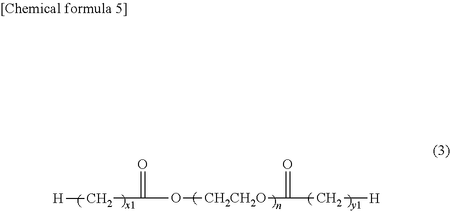

In the general formula (3), x1 and y1 each independently represent an integer of 15 or more and 19 or less, and n represents an integer of 170 or more and 210 or less.

Here, the amount of the droplet adjusting agent in the ink is preferably 0.1% by mass or more and 4.0% by mass or less, more preferably 0.4% by mass or more and 2.0% by mass or less with respect to the total mass of the ink. When the amount of the liquid droplet adjusting agent is 0.1% by mass or more, the surface of the droplet is easily covered with the liquid droplet adjusting agent when the ink is ejected from an inkjet nozzle, and satellites and mist are less likely to be generated. In addition, post-processability of an image (cured product of the ink) to be obtained is also more likely to become favorable. On the other hand, when the amount of the droplet adjusting agent is 4.0% by mass or less, the ejectability from inkjet nozzles is less likely to be affected, and a printed material with higher quality is more likely to be obtained.

### [Photopolymerizable Compound]

The ink according to the present embodiment contains a photopolymerizable compound. The photopolymerizable compound may be any compound that is polymerized by irradiation with active rays, and the photopolymerizable compound may be a radically polymerizable compound or a cationically polymerizable compound. It is preferable that the photopolymerizable compound is a radically polymerizable compound from the viewpoint of the curability thereof.

The radically polymerizable compound may be a compound (a monomer, an oligomer, a polymer, or a mixture of these) having a radically polymerizable ethylenically unsaturated bond. The ink may contain only one type of radically polymerizable compound as the photopolymerizable compound, or may contain two or more types thereof.

Examples of the compound having a radically polymerizable ethylenically unsaturated bond include unsaturated carboxylic acids and salts thereof, unsaturated carboxylic acid ester compounds, unsaturated carboxylic acid urethane compounds, unsaturated carboxylic acid amide compounds and anhydrides thereof, acrylonitrile, styrene, unsaturated polyester, unsaturated polyethers, unsaturated polyamides, and unsaturated urethanes. Examples of the unsaturated carboxylic acid include (meth)acrylic acids, itaconic acid, crotonic acid, isocrotonic acid, and maleic acid.

Among the above, the radically polymerizable compound is preferably an unsaturated carboxylic acid ester compound, and more preferably a (meth)acrylate-based compound. Note that in the present specification, the term “(meth)acrylate” includes acrylate, methacrylate, and a mixture thereof.

Examples of the (meth)acrylate-based compound include the following: monofunctional monomers such as isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethylhexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethylsuccinic acid, 2-(meth)acryloyloxyethylphthalic acid, 2-(meth)acryloyloxyethyl-2-hydroxyethyl-phthalic acid and t-butylcyclohexyl (meth)acrylate; difunctional monomers such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-PO adduct di(meth)acrylate, neopentyl glycol hydroxypivalate di(meth)acrylate, polytetramethylene glycol di(meth)acrylate, polyethylene glycol diacrylate, tripropylene glycol diacrylate, and tricyclodecane dimethanol diacrylate; trifunctional or higher polyfunctional monomers such as trimethylolpropane tri(meth)acrylate, pentaerythritol tri(meth)acrylate, pentaerythritol tetra(meth)acrylate, dipentaerythritol hexa (meth)acrylate, ditrimethylolpropane tetra(meth)acrylate, glycerolpropoxy tri(meth)acrylate, pentaerythritol ethoxy tetra(meth)acrylate, ethylene oxide-modified trimethylolpropane tri(meth)acrylate, propylene oxide-modified trimethylolpropane tri(meth)acrylate, ethylene oxide-modified pentaerythritol tetraacrylate, caprolactone-modified trimethylolpropane tri(meth)acrylate, and caprolactam-modified dipentaerythritol hexa (meth)acrylate; polymers (oligomers) of the above monomers; mixtures of the above monomers and oligomers; and modified products thereof.

When the (meth)acrylate-based compound is a modified product of the monomer, the modified product may contain a polymerizable functional group other than the unsaturated double bond in the structure thereof. Examples of the (meth)acrylate-based compound having such a polymerizable functional group include amine-modified (meth)acrylate oligomers, epoxy (meth)acrylate oligomers, aliphatic urethane (meth)acrylate oligomers, aromatic urethane (meth)acrylate oligomers, polyester (meth)acrylate oligomers, and linear (meth)acryl oligomers.

Among the (meth)acrylate-based compounds, stearyl (meth)acrylate, lauryl (meth)acrylate, isostearyl (meth)acrylate, ethoxydiethylene glycol (meth)acrylate, isobornyl (meth)acrylate, tetraethylene glycol di(meth)acrylate, glycerin propoxy tri(meth)acrylate, tripropylene glycol di(meth)acrylate, polyethylene glycol di(meth)acrylate; (propylene oxide-modified) trimethylolpropane tri(meth)acrylate, ditrimethylolpropane tetra(meth)acrylate, and amine-modified (meth)acrylate oligomers are preferable from the viewpoint of photosensitivity and the like.

On the other hand, examples of the cationically polymerizable compound, which may be a photopolymerizable compound, include epoxy compounds, vinyl ether compounds, and oxetane compounds. The ink may contain only one type of cationically polymerizable compound as the photopolymerizable compound, or may contain two or more types thereof.

The epoxy compound may be an aromatic epoxide, a cycloaliphatic epoxide, an aliphatic epoxide, and the like. Among these, aromatic epoxides and alicyclic epoxides are preferable from the viewpoint of increasing the curability of the ink.

The aromatic epoxide may be a di- or polyglycidyl ether obtained by reacting a polyhydric phenol or an alkylene oxide adduct thereof with epichlorohydrin. Examples of the polyhydric phenol or an alkylene oxide adduct thereof to be reacted include bisphenol A or alkylene oxides adducts thereof. The alkylene oxide in the alkylene oxide adduct may be ethylene oxide, propylene oxide, or the like.

The alicyclic epoxide may be a cycloalkane oxide-containing compound obtained by epoxidizing a cycloalkane-containing compound with an oxidizing agent such as hydrogen peroxide or a peracid. The cycloalkane in the cycloalkane oxide-containing compound may be cyclohexene or cyclopentene.

The aliphatic epoxide may be a di- or polyglycidyl ether obtained by reacting an aliphatic polyhydric alcohol or an alkylene oxide adduct thereof with epichlorohydrin. Examples of the aliphatic polyhydric alcohol include alkylene glycols such as ethylene glycol, propylene glycol, and 1,6-hexanediol. The alkylene oxide in the alkylene oxide adduct may be ethylene oxide, propylene oxide, or the like.

Examples of the vinyl ether compound include the following:
monovinyl ether compounds such as ethyl vinyl ether, N-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether, and
di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, and trimethylolpropane trivinyl ether. Among these vinyl ether compounds, di- or tri-vinyl ether compounds are preferable in consideration of curability, adhesion, and the like.

The oxetane compound is a compound having an oxetane ring. Examples thereof include oxetane compounds described in Japanese Unexamined Patent Publication No. 2001-220526, Japanese Unexamined Patent Publication No. 2001-310937, Japanese Unexamined Patent Publication No. 2005-255821. Preferred are the compounds represented by the general formula (1) described in paragraph 0089, the general formula (2) described in paragraph 0092, the general formula (7) described in paragraph 0107, the general formula (8) described in paragraph 0109, and the general formula (9) described in paragraph 0116, and the like in Japanese Unexamined Patent Publication No. 2005-255821. The general formulae (1), (2), (7), (8), and (9) described in Japanese Unexamined Patent Publication No. 2005-255821 are illustrated below.

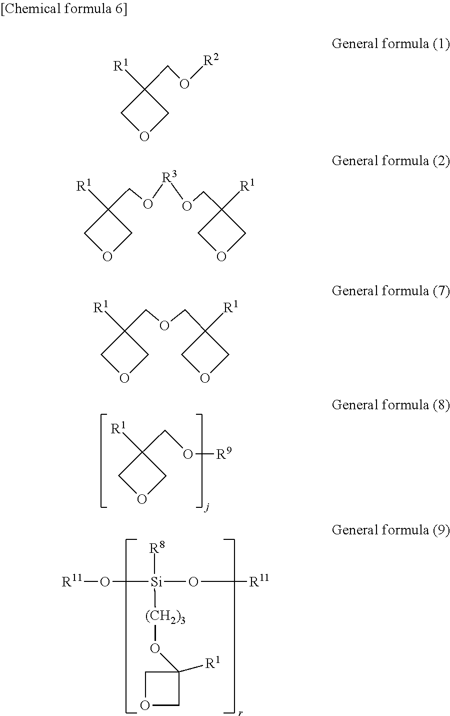

Here, the content of the photopolymerizable compound in the ink may be 70% by mass or more with respect to the total mass of the ink, but is preferably 75% by mass or more and 98% by mass or less, and more preferably 80% by mass or more and 96% by mass or less, from the viewpoint of the curability of the ink or the like.

### [Photoinitiator]

The photoinitiator may be any compound that can be activated by irradiation with active rays to initiate polymerization of the photopolymerizable compound. The ink may contain only one type of photoinitiator, or may contain two or more types of photoinitiators. The photoinitiator may be of an intramolecular bond cleavage type or an intramolecular hydrogen abstraction type.

Examples of the intramolecular bond cleavage type photoinitiator include the following: acetophenone-based initiators such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenylketone, 2-methyl-2-morpholino(4-thiomethylphenyl)propan-1-one, and 2-benzyl-2-dimethylamino-1-(4-morpholinophenyl)-butanone; benzoin-based initiators such as benzoin, benzoin methyl ether, and benzoin isopropyl ether, acylphosphine oxide-based initiators such as 2,4,6-trimethylbenzoin diphenylphosphine oxide; and benzyl glyoxyester-based initiators; and methylphenyl glyoxyester-based initiators.

Examples of the intramolecular hydrogen abstraction type photoinitiator include the following: benzophenone-based initiators such as benzophenon, methyl o-benzoylbenzoate-4-phenylbenzophenon, 4,4′-dichlorobenzophenon, hydroxybenzophenon, 4-benzoyl-4′-methyl-diphenylsulfide, acrylated benzophenon, 3,3′, 4,4′-tetra(t-butylperoxycarbonyl)benzophenon, and 3,3′-dimethyl-4-methoxybenzophenon; and thioxanthone-based initiators such as 2-isopropylthioxanthone, 2,4-dimethylthioxanthone, 2,4-diethylthioxanthone, and 2,4-dichlorothioxanthone; aminobenzophenone initiators such as Michler's ketone and 4,4′-diethylaminobenzophenone; and 10-butyl-2-chloroacridone, 2-ethylanthraquinone, 9,10-phenanthrenequinone, camphorquinone, and the like.

When the photoinitiator is an acylphosphine oxide or an acyl phosphonate, the sensitivity to active rays becomes satisfactory, and the curability of the ink becomes satisfactory. More preferably, the photoinitiator is bis(2,4,6-trimethylbezoyl)-phenylphosphineoxide, or bis(2,6-dimethoxybenzoyl)-2,4,4-trimethyl-pentylphosphineoxide.

Note that the photoinitiator may be a photoacid generator. Examples of the photoacid generator include compounds used for chemically amplified photoresists and photocationic polymerization (see “Organic Materials for Imaging”, edited by The Society for the Study of Organic Electronics Materials, Bunshin Shuppan (1993), page 187 to 192).

The content of the photoinitiator in the ink is appropriately selected also according to the active rays to be emitted for curing the ink, the type of photopolymerizable compound, and the like. The content of the photoinitiator is preferably 0.1% by mass or more and 10% by mass or less, more preferably 2% by mass or more and 8% by mass or less with respect to the total mass of the ink.

### [Pigment]

The pigment contained in the ink of the present embodiment is appropriately selected according to the use of the ink. The ink may contain only one type of pigment or two or more types of pigment. The type of pigment is not particularly limited, and known pigment can be used. For example, organic pigments or inorganic pigments having the following numbers listed in the Color Index can be selected.

Examples of red or magenta pigment include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, Pigment Orange 13, 16, 20, and 36, and solid solutions of any two or more of these magenta pigments.

Examples of blue or cyan pigment include Pigment Blue 1, 15, 15:1, 15:2, 15:3, 15:4, 15:6, 16, 17-1, 22, 27, 28, 29, 36, and 60.

Examples of green pigments include Pigment Green 7, 26, 36, 50. Examples of yellow pigments include Pigment Yellow 1, 3, 12, 13, 14, 17, 34, 35, 37, 55, 74, 81, 83, 93, 94, 95, 97, 108, 109, 110, 137, 138, 139, 150, 153, 154, 155, 157, 166, 167, 168, 180, 185, and 193.

Examples of the black pigment include Pigment Black 7, 28, and 26. As the white pigment, titanium oxide (particularly, rutile-type titanium dioxide) can also be used.

The volume average particle size of the pigment measured by a dynamic scattering method or a laser diffraction method is preferably 0.08 μm or more and 0.5 μm or less. The maximum particle size of the pigment is preferably 0.3 sim or more and 10 μm or less, more preferably 0.3 μm or more and 3 μm or less. When the particle size of the pigment is within the above range, the ink is easily ejected from an inkjet nozzle. Furthermore, the storage stability of the ink is more likely to become satisfactory.

The amount of the pigment in the ink is preferably 0.1% by mass or more and 20% by mass or less, more preferably 0.4% by mass or more and 10% by mass or less. When the amount of the pigment is within the above range, an image having a desired color is more likely to be obtained. On the other hand, the viscosity of the ink does not excessively increase, making it easier to eject the ink from the inkjet nozzles.

### [Pigment-Dispersing Agent]

The pigment-dispersing agent is appropriately selected according to the type of pigment. The ink may contain only one type of pigment-dispersing agent or two or more types of pigment-dispersing agent.

Examples of the pigment-dispersing agent include hydroxyl group-containing carboxylic acid esters, salts of long-chain polyaminoamides and high-molecular weight acid esters, salts of high-molecular weight polycarboxylic acids, salts of long-chain polyaminoamides and polar acid esters, high-molecular weight unsaturated acid esters, high-molecular weight copolymers, modified polyurethanes, modified polyacrylates, polyether ester-type anionic surfactants, naphthalenesulfonic acid-formalin condensate salts, aromatic sulfonic acid-formalin condensate salts, polyoxyethylene alkyl phosphate esters, polyoxyethylene nonylphenyl ether, and stearylamine acetate. Examples of commercially available pigment-dispersing agent include Solsperse series manufactured by Avecia Co., Ltd. and PB series manufactured by Ajinomoto Fine-Techno Co., Inc.

The ink may further contain a known dispersion aid, if necessary. The dispersion aid is appropriately selected depending on the type of pigment. An example thereof is SOLSPERSE 22000 (Disazo Yellow Intermediate, manufactured by Lubrizol Corporation) which is generally used for dispersing a yellow pigment. The sum of the amounts of the pigment-dispersing agent and the dispersion aid is preferably 1% by mass or more and 50% by mass or less based on the pigment.

### [Gelling Agent]

The ink may further contain a gelling agent, if necessary. The gelling agent in the present specification is “an organic substance that is solid at normal temperature and becomes liquid when heated, and is a compound having a function of causing the active ray curable inkjet ink to undergo a temperature-induced reversible sol-gel phase transition”.

The gelling agent is preferably a compound that crystallizes at a temperature equal to or lower than the gelation temperature of the ink. The gelation temperature of the ink refers to a temperature at which the gelling agent undergoes a phase transition from sol to gel and the viscosity of the ink suddenly changes when the ink that has been solated or liquefied by heating is cooled. Specifically, the solated or liquefied ink is cooled while measuring the viscosity with a viscoelasticity measurement apparatus (for example, MCR300, manufactured by Physica), and the temperature at which the viscosity rapidly increases is taken as the gelation temperature of the ink.

When the gelling agent is crystallized in the ink, a structure may be formed in which the photopolymerizable compound is included in a three dimensional space formed by the gelling agent crystallized in a plate shape. In the present specification, such a structure is also referred to as a “card house structure”. Then, when the card house structure is formed in the ink, the photopolymerizable compound is held in the space. Therefore, the ink droplet is less likely to wet-spread, and the pinning properties of the ink are enhanced. When the pinning properties of the ink are enhanced, the ink droplets landed on the recording medium are less likely to coalesce with each other, and thus a higher-definition image can be formed.

In order to hold the photopolymerizable compound in the card house structure, the photopolymerizable compound and the gelling agent are preferably compatible with each other in the ink. In addition, it is preferable that the compatibility between the photopolymerizable compound and the gelling agent is satisfactory also from the viewpoint of stably ejecting droplets of the ink from an inkjet nozzle.

Here, examples of the gelling agent include the following: aliphatic ketone compounds; aliphatic ester compounds; petroleum-based waxes such as paraffin wax, microcrystalline wax, and petrolatum; vegetable waxes such as candelilla wax, carnauba wax, rice wax, wood wax, jojoba oil, jojoba solid wax, and jojoba esters; animal waxes such as beeswax, lanolin, and spermaceti; mineral waxes such as montan wax and hydrogenated wax; hydrogenated castor oil or hydrogenated castor oil derivatives; modified waxes such as montan wax derivatives, paraffin wax derivatives, microcrystalline wax derivatives, or polyethylene wax derivatives; higher fatty acids such as behenic acid, arachidic acid, stearic acid, palmitic acid, myristic acid, lauric acid, oleic acid, and erucic acid; higher alcohols such as stearyl alcohol and behenyl alcohol; hydroxystearic acids such as 12-hydroxystearic acid; 12-hydroxystearic acid derivatives; fatty acid amides such as lauric acid amide, stearic acid amide, behenic acid amide, oleic acid amide, erucic acid amide, ricinoleic acid amide, and 12-hydroxystearic acid amide (e.g., Nikkaamide series manufactured by Nippon Kasei Chemical Co., Ltd., ITOWAX series manufactured by Itoh Oil Chemicals Co., Ltd, and FATTYAMID series manufactured by Kao Corporation); N-substituted fatty acid amides such as N-stearyl stearic acid amide and N-oleyl palmitic acid amide; special fatty acid amides such as N,N-ethylenebisstearylamide, N,N′-ethylenebis-12-hydroxystearylamide, and N,N′-xylylenebisstearylamide; higher amines such as dodecylamine, tetradecylamine or octadecylamine; fatty acid ester compounds such as stearylstearic acid, oleylpalmitic acid, glycerin fatty acid ester, sorbitan fatty acid ester, propylene glycol fatty acid ester, ethylene glycol fatty acid ester, and polyoxyethylene fatty acid ester (for example, EMALLEX series manufactured by Nippon Emulsion Co., Ltd., Riekmar series manufactured by Riken Vitamin Co., Ltd., Poem series manufactured by Riken Vitamin Co., Ltd., and the like); esters of sucrose fatty acids such as sucrose stearic acid and sucrose palmitic acid (e.g., Ryoto Sugar Ester Series manufactured by Mitsubishi Chemical Foods Corporation); synthetic waxes such as polyethylene wax and α-olefin-maleic anhydride copolymer wax (e.g., UNILIN series manufactured by Baker-Petrolite Corporation); dimer acid; dimer diols (such as PRIPOR series manufactured by CRODA); fatty acid inulin such as inulin stearate; fatty acid dextrins such as dextrin palmitate and dextrin myristate (e.g., LEOPAL series manufactured by Chiba Milling Co., Ltd); glyceryl eicosanedioate behenate; eicosane-polyglyceryl behenate (Nomcoat series and the like manufactured by Nisshin OilliO Group, Ltd); amide compounds such as N-lauroyl-L-glutamic acid dibutylamide and N-(2-ethylhexanoyl)-L-glutamic acid dibutylamide (available from Ajinomoto Fine-Techno Co., Inc); dibenzylidene sorbitols such as 1,3,2,4-bis-O-benzylidene-D-glucitol (Gelol D available from New Japan Chemical Co., Ltd); low molecular weight oil gelling agents described in Japanese Unexamined Patent Publication No. 2005-126507, Japanese Unexamined Patent Publication No. 2005-255821 and Japanese Unexamined Patent Publication No. 2010-111790; and the like.

The gelling agent preferably contains a linear or branched alkyl group having 12 or more and 26 or less carbon atoms in the molecular structure thereof. When the gelling agent contains the alkyl group, the above-described “card house structure” is easily formed. When the gelling agent contains a linear alkyl group having 12 or more and 26 or less carbon atoms in the molecular structure, the card house structure is more easily formed.

Specific examples of the gelling agent containing a linear or branched alkyl group having 12 or more and 26 or less carbon atoms include aliphatic ketone compounds, aliphatic ester compounds, higher fatty acids, higher alcohols, fatty acid amides, and the like, each having the above-described alkyl group.

The gelling agent is more preferably an aliphatic ketone compound or an aliphatic ester compound, and is preferably a compound represented by the following general formula (G1) or (G2).

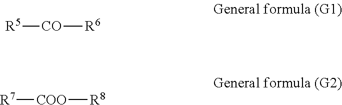

In the general formula (G1) and (G2), R⁵ to R⁸ each independently represent a linear or branched alkyl group having 12 or more and 26 or less carbon atoms. R⁵ to R⁸ may each partially include a branched chain portion.

The alkyl group represented by R⁵ and R⁶ in the general formula (G1) are not particularly limited, but are preferably alkyl groups having 12 or more and 26 or less carbon atoms and not containing a branched chain.

Examples of the aliphatic ketone compound represented by the above-described general formula (G1) include 18-pentatriacontanone (C17-C17), dilignoceryl ketone (C24-C24), dibehenyl ketone (C22-C22), distearyl ketone (C18-C18), dieicosyl ketone (C20-C20), dipalmityl ketone (C16-C16), dimyristyl ketone (C14-C14), dilauryl ketone (C12-C12), lauryl myristyl ketone (C12-C14), lauryl palmityl ketone (C12-C16), myristyl palmityl ketone (C14-C16), myristyl stearyl ketone (C14-C18), myristyl behenyl ketone (C14-C22), palmityl stearyl ketone (C16-C18), palmityl behenyl ketone (C16-C22), and stearyl behenyl ketone (C18-C22).

Examples of commercially available products of the compound represented by the general formula (G1) include 18-Pentatriacontanon (manufactured by Alfa Aeser), Hentriacontan-16-on (manufactured by Alfa Aeser), and Kao Wax T1 (manufactured by Kao Corporation). The ink may contain only one type of aliphatic ketone compound or may contain two or more types of aliphatic ketone compounds as the gelling agent.

On the other hand, in the general formula (G2), the alkyl group represented by R⁷ and R⁸ are not particularly limited, but are preferably alkyl groups which do not include a branched chain having 12 to 26 carbon atoms.

Examples of the aliphatic ester compound represented by the general formula (G2) include behenyl behenate (C21-C22), icosanoic acid icosyl (C19-C20), stearyl stearate (C17-C18), palmityl stearate (C17-C16), lauryl stearate (C17-C12), behenyl stearate (C17-C22), cetyl palmitate (C15-C16), stearyl palmitate (C15-C18), myristyl myristate (C13-C14), cetyl myristate (C13-C16), octyldodecyl myristate (C13-C20), stearyl oleate (C17-C18), stearyl erucate (C21-C18), stearyl linoleate (C17-C18), behenyl oleate (C18-C22), myricyl cerotenate (C25-C16), stearyl montanate (C27-C18), behenyl montanate (C27-C22), arachidyl linoleate (C17-C20), palmityl triacontanoate (C29-C16), and the like.

Examples of commercially available products of the aliphatic ester compound represented by the general formula (G2) include UNISTER M-2222SL (manufactured by NOF Corporation), EXCEPARL SS (manufactured by Kao Corporation), EMALEX CC-18 (manufactured by Nihon Emulsion Co., Ltd), AMREPS PC (manufactured by Higher Alcohol Industries, Ltd), EXCEPARL MY-M (manufactured by Kao Corporation), SPERMACETI (manufactured by NOF Corporation), EMALEX CC-10 (manufactured by Nihon Emulsion Co., Ltd), and WE (manufactured by NOF Corporation). These commercially available products are often mixtures of two or more types, and therefore, may be subjected to separation and purification, if necessary. Furthermore, the ink nay contain, as a gelling agent, only one type of aliphatic ester compound, or two or more types of aliphatic ester compounds.

The content of the gelling agent in the ink is preferably 0.5% by mass or more and 10% by mass or less, more preferably 1% by mass or more and 7% by mass or less with respect to the total mass of the ink.

### [Other Components]

The ink may further contain a photoinitiator aid, a polymerization inhibitor, and the like, if necessary, in addition to the above-described components. Examples of the photoinitiator aid include tertiary amine compounds. Among these, aromatic tertiary amine compounds are preferable. Examples of the aromatic tertiary amine compound include N,N-dimethylaniline, N,N-diethylaniline, N,N-dimethyl-p-toluidine, N,N-dimethylamino-p-benzoic acid ethyl ester, N,N-dimethylamino-p-benzoic acid isoamylethyl ester, N,N-dihydroxyethylaniline, triethylamine, and N,N-dimethylhexylamine. Among these, N,N-dimethylamino-p-benzoic acid ethyl ester and N,N-dimethylamino-p-benzoic acid isoamylethyl ester are preferable. The ink nay contain only one type of photoinitiator aid, or may contain two or more types thereof.

Examples of the polymerization inhibitor include (alkyl)phenols, hydroquinone, catechol, resorcinol, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) anilineoxide, dibutylcresol, cyclohexanoneoxime cresol, guaiacol, o-isopropylphenol, butyraldoxime, methyl ethyl ketoxime, cyclohexanone oxime and the like.

The ink may further contain other components, if necessary. The other components may be various additives, other resins, and the like. Examples of the additive include surfactants, leveling additives, matting agents, ultraviolet absorbers, infrared rays absorbers, antibacterial agents, and basic compounds for enhancing the storage stability of the ink. Examples of the basic compound include basic alkali metal compounds, basic alkaline earth metal compounds, and basic organic compounds such as amines. Examples of the other resins include resins for adjusting physical property of a cured product, and the like, and include, for example, polyester-based resins, polyurethane-based resins, vinyl-based resins, acrylic-based resins, rubber-based resins, and the like.

### [Physical Property of Ink]

The ink described above has a different viscosity between when the ink includes the gelling agent and when the ink does not include the gelling agent. For example, the viscosity of an ink that does not contain a gelling agent at 25° C. is preferably 1 mPa·s or more and 30 mPa·s or less and more preferably 5 mPa·s or more and 20 mPa·s or less. When the viscosity is within the above range, the ink is easily ejected from an inkjet nozzle, and ink droplet is easily generated. The viscosity is a value measured with a rheometer. As the rheometry, stress-controlled rheometry PhysicaMCR series manufactured by Anton Paar Co., Ltd. can be used. The cone plate may have a diameter of 75 mm and a cone angle of 1.0°. The viscosity can be adjusted by, for example, the type and amount of the photopolymerizable compound.

On the other hand, when the ink contains a gelling agent, the ink undergoes a temperature-induced reversible sol-gel phase transition. The active ray curable ink which undergoes sol-gel phase transition is a liquid (sol) at a high temperature (for example, about 80° C.), and thus can be ejected in a sol state from an inkjet recording head. When an active ray curable inkjet ink is ejected at high temperature, an ink droplet (dot) lands on a recording medium and then is naturally cooled to gel. Thus, coalescence of adjacent dots can be suppressed and image quality can be improved.

The ink containing a gelling agent preferably has a viscosity of the ink at high temperature of a certain level or lower in order to enhance the ejection property of ink droplet. To be specific, the viscosity of the ink at 80° C. is preferably 3 mPa·s or more and 20 mPa·s or less. On the other hand, in order to suppress coalescence of adjacent dots, the viscosity of the ink at room temperature after landing is preferably a certain level or more. To be specific, the viscosity of the ink at 25° C. is 1000 mPa·s or more.

The gelation temperature of the ink is preferably 30° C. or more and less than 100° C., more preferably 50° C. or more and 65° C. or less. When the gelation temperature of the ink is too high, gelation tends to occur at the time of ejection, so that the ejection property tends to become low. On the other hand, when the gelation temperature of the ink is excessively low, the ink is less likely to be rapidly gelled after landing on a recording medium. Note that the gelation temperature is a temperature at which the ink in a sol state is gelled and its fluidity decreases in a process of cooling the ink.

The viscosity at 80° C., the viscosity at 25° C., and the gelation temperature of the inkjet ink can be determined by measuring a temperature change in the dynamic viscoelasticity of the ink with a rheometer. Specifically, a temperature change curve of viscosity is obtained when the ink is heated to 100° C. and cooled to 20° C. under conditions of a shear rate of 11.7 (/s) and a temperature lowering rate of 0.1° C./s. The viscosity at 80° C. and the viscosity at 25° C. are the viscosities at 80° C. and 25° C. in the temperature change curve. The gelation temperature is defined as a temperature at which the viscosity becomes 200 mPa·s in a temperature change curve of viscosity. The rheometer is the same as described above.

An ink that undergoes the sol-gel phase transition can suppress coalescence of droplets by ejecting droplets that are in a liquid state at a high temperature, landing the droplets on a recording medium, and at the same time, cooling and gelling the droplets. Thus, a high-definition image can be formed even when high-speed recording is performed.

### [Method for Preparing Inkjet Ink]

The ink is obtained by mixing the droplet adjusting agent, the photopolymerizable compound, the photoinitiator, the pigment, and the pigment-dispersing agent, and if necessary, a gelling agent and the like. The mixing method is not particularly limited, but for example, it is preferable to prepare a composition in which a pigment, a pigment-dispersing agent, and the like are dispersed in a part of the photopolymerizable compound and mix the composition with other components. The obtained ink is preferably filtered with a predetermined filter.

### 2. Method for Producing Printed Material

The method for producing a printed material according to the present embodiment includes at least the following two steps.
(1) Ejecting ink droplets of the ink from an inkjet recording head to cause the ink droplets to land on a recording medium step
(2) Irradiating the ink droplets having landed on the recording medium with active rays to cure the ink droplets
   [about Step (1)]

In this step, ink droplets of the above-described ink are ejected from an inkjet recording head and allowed to land on a recording medium at positions corresponding to an image to be formed.

The ejection method from the inkjet recording head may be either an on-demand method or a continuous method. The inkjet head of the on-demand system may be any of an electro-mechanical conversion system such as a single cavity type, a double cavity type, a bender type, a piston type, a share mode type, and a shared wall type, and an electro-thermal conversion system such as a thermal inkjet type and a bubble jet (Bubble Jet is a registered trademark of Canon Inc) type.

An ink droplet not containing a gelling agent can be ejected from an inkjet head at normal temperature, but an ink droplet containing a gelling agent can be ejected from an inkjet head in a heated state to enhance ejection stability. The temperature of the ink during ejection is not particularly limited, but is preferably 35° C. or more and 100° C. or less in a case of using an ink containing a gelling agent, and is more preferably 35° C. or more and 80° C. or less in order to further enhance ejection stability. In particular, it is preferable to perform ejection at an ink temperature at which the viscosity of the ink becomes 7 mPa·s or more and 15 mPa·s or less, and more preferably 8 mPa·s or more and 13 mPa·s or less.

The ink can be heated in an inkjet recording head of an inkjet recording apparatus, an ink channel connected to the inkjet recording head, an ink tank connected to the ink channel, or the like.

The droplet amount of one droplet ejected from each nozzle of the inkjet recording head is preferably 0.5pl or more and 10 pl or less, and more preferably 0.5 pl or more and 2.5 pl or less in order to form a high-definition image.

Note that in a case where the ink contains a gelling agent, it is preferable that the ink droplet landed on the recording medium undergoes sol-gel phase transition by cooling so as to be rapidly gelled. Thus, the ink droplet can be pinned without being spread. Furthermore, since oxygen is less likely to enter the ink droplet, curing of the photopolymerizable compound is less likely to be inhibited by oxygen.

The recording medium may be either paper or a resin film. Examples of the paper include coated printing paper and coated printing paper B. In addition, examples of the resin film include polyethylene terephthalate films, polypropylene films, and vinyl chloride films.

The conveyance speed of the recording medium is preferably 30 to 120 m/min.

[about Step (2)]

The ink droplet landed on the recording medium is irradiated with active rays to polymerize the photopolymerizable compound contained in the ink droplet, thereby curing the ink droplet.

The active ray can be selected from for example, electron beam, ultraviolet ray, visible light, α-ray, γ-ray, X-ray, and the like. Among these, ultraviolet ray or visible light is preferred, and an LED light source that emits light having a peak wavelength of 360 nm or more and 500 nm or less is more preferred. An LED emits less radiant heat than a conventional light source (e.g., a metal halide lamp). Therefore, upon irradiation with active rays, the ink is less likely to dissolve, and gloss unevenness and the like are less likely to occur.

In the case of irradiation with light having peak wavelength in the range of 360 nm to 410 nm, the peak illuminance at the surfaces of the recording medium or the surfaces of the ink droplets is preferably 0.5 W/cm² to 10.0 W/cm². The peak illuminance is more preferably 1.0 W/cm² or more and 5.0 W/cm² or less.

The irradiation with active rays is preferably performed between 0.001 seconds and 1.0 seconds after the ink lands on the recording medium. In order to form a high-definition image, it is more preferable to perform the exposure for 0.001 seconds to 0.5 seconds.

On the other hand, the irradiation with active rays may be performed in two stages. In this case, it is possible to temporarily cure the ink by irradiating the ink with active rays between 0.001 seconds and 2.0 seconds after the ink has landed on the recording medium, and to fully cure the ink by further irradiating the ink with active rays after completion of all printing. When the irradiation with active rays is divided into two stages, the curing shrinkage of the ink is less likely to occur.

### Examples

Hereinafter, the present invention will be specifically described with reference to examples, but the embodiments of the present invention are not limited to these examples.

### 1. Preparation of Materials

The following materials were prepared.

### <Pigment>

Yellow pigment: VERSAL YELLOW 4GM (Synthesia)

### <Photopolymerizable Compound>

Phenol EO-modified acrylate: Miramer (registered trademark) M144 (manufactured by MIWON)
Polyethylene glycol #400 diacrylate (PEGDA)
4EO modified pentaerythritol tetraacrylate (4EO modified PETA)
3PO modified trimethylolpropane triacrylate (3PO modified TMPTA)

### <Photopolymerization Initiator>

photopolymerization initiator: IRGACURE (registered trademark) 819 (manufactured by BASF)

### <Pigment-Dispersing Agent>

Polymeric pigment-dispersing agent: Ajisper PB821 (manufactured by Ajinomoto Fine-Techno Co., Inc.)

### <Photopolymerization Inhibitor>

Photopolymerization inhibitor: Irgastab (registered trademark) UV10 (manufactured by BASF)

### <Droplet Adjusting Agent (Droplet Adjusting Agents Represented by the General Formula (1))>

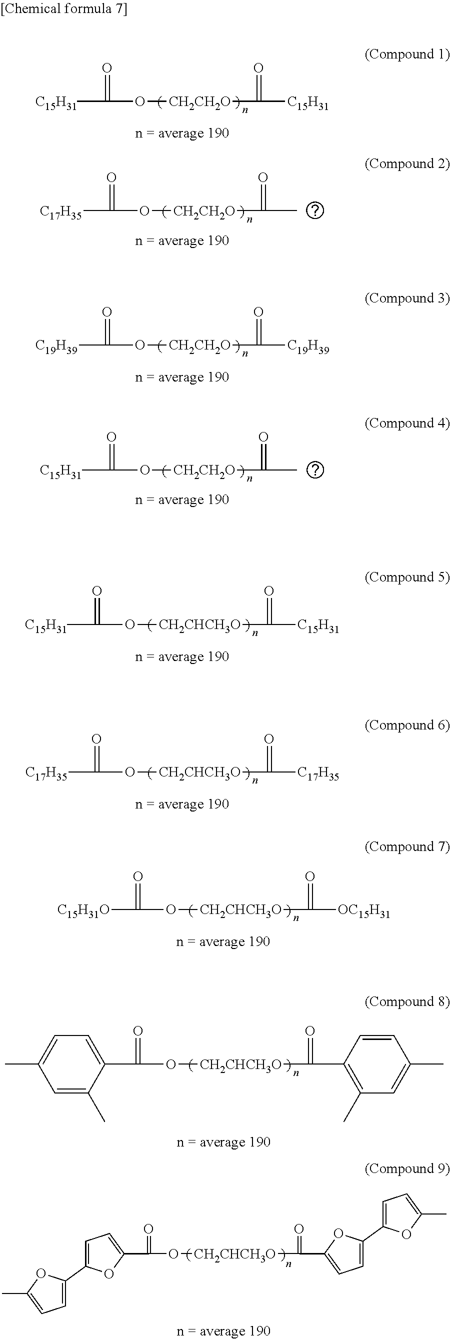

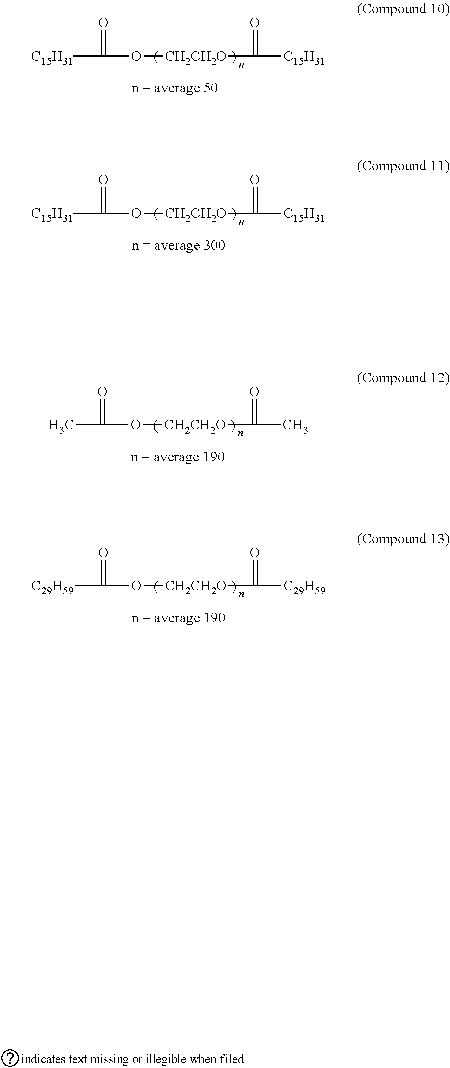

### <Droplet Adjusting Agent (Other Compounds)>

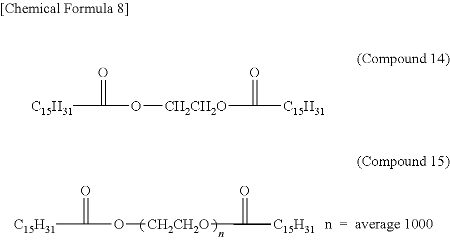

### <Gelling Agent>

gelling agent: “AMREPS PC” (cetyl palmitate, manufactured by Kokyu Alcohol Kogyo Co., Ltd.)

### 2. Preparation of Ink

### (1) Preparation of Pigment Dispersion Liquid

As a material of the pigment dispersion liquid, the components were mixed at a composition ratio shown below. Next, the mixture and 0.3 mm of zirconia beads (YTZ balls, manufactured by Nikkato Corporation) were placed in a 100 mL plastic container. The mixture was dispersed for 3 hours in a paint shaker, and then, the zirconia beads were removed to obtain a pigment dispersion composition 1.

### (Composition of Pigment Dispersion Liquid)

Polymeric pigment-dispersing agent: Ajisper PB821 (manufactured by Ajinomoto Fine-Techno Co., Inc.) (6.5 parts by mass).
Phenol EO-modified acrylate: Miramer (registered trademark) M144 (manufactured by MIWON) 73.2 parts by mass
Photopolymerization inhibitor: Irgastab (registered trademark) UV10 (manufactured by BASF) 0.3 parts by mass

### (2) Preparation of Ink 1 to 20

The components were mixed in the composition ratios listed in Table 1, and the mixture was stirred at 105° C. for 45 minutes. Thereafter, the mixtures were filtered through a 3-μm membrane filter (Teflon (registered trademark)) produced by ADVANTEC) to prepare each f inks 1 to 20.

### 3. Evaluation

The satellite and mist evaluation and the image gloss of the obtained printed material were performed by the following methods.

### (1) Satellite and Mist Evaluation

An inkjet ejection evaluation apparatus having an inkjet recording head provided with a piezo-type inkjet nozzle was filled with the ink. Then, one droplet of the ink was ejected from the ink ejection evaluation apparatus, and the state after the ejection was observed with a JetXpert droplet observation apparatus (manufactured by ImageXpert). Then, satellites and mist were evaluated according to the following standard. ⊚, ∘, and Δ are acceptable.
⊚: generation of any of the satellite and the mist cannot be confirmed
∘: the total number of satellites and mists with respect to one main droplet is 1 or more and 2 or less
Δ: the total number of satellites and mists with respect to one main liquid droplet is 3 or more and 5 or less
x: the total number of satellites and mists is 6 or more with respect to one main droplet

### (2) Evaluation of Post-Processability

A monochrome image was formed using an inkjet recording apparatus of a line recording system. An ink supply system of the inkjet recording apparatus is configured by an ink tank, a supply pipe, a sub ink tank immediately before a head, a pipe with a filter, and a piezo head (inkjet recording head), all of which in communication with each other in this order. The inkjet ink obtained above was supplied to the ink supply system of the inkjet recording apparatus, and printing was performed.

The inkjet recording head used had 1776 nozzles, and two inkjet heads manufactured by Konica Minolta, Inc. having 600 dpi resolution were modularized so as to have 1200 dpi as one set. The applied voltage was adjusted so that the droplet amount of one droplet became 3.5 pl, and an image was formed. Herein, dpi stands for the number of dots per 2.54 cm. The image formation was performed under an environment of 23° C. and 55% RH.

Double-sided Yupo Super Yupo Double FRBW 130 μm was prepared as the recording medium. The temperature of the recording medium was adjusted to 30° C. by a temperature controller. The conveyance speed of the recording medium was set to 1000 mm/s. Then, ink droplets were ejected onto the recording medium from the inkjet recording head to form a solid image.

After image formation, the recording medium was irradiated with active rays using an LED lamp (manufactured by Kyocera Corporation, 8 W/cm², wavelength of 450 nm, irradiation width of 68 mm, distance from LED lamp to recording medium surface of 50 mm, illuminance on recording medium of 2.0 W/cm²) disposed downstream of the inkjet recording apparatus, with the cumulative light amount being 350 mJ. A line was drawn on the obtained image with a dyne pen. Then, the upper limit of the numerical value at which the drawn line did not turn into a water droplet and remained unchanged for 2 to 4 seconds was calculated, and evaluation was performed according to the following evaluation criteria. ⊚, ∘, and Δ are acceptable.
⊚: 35 mN/m or more
∘: equal to or more than 30 mN/m and less than 35 mN/m
Δ: equal to or more than 25 mN/m and less than 30 mN/m
x: less than 25 mN/m

TABLE 1

| | | | | | Photopolymerizable | | | | |
|---|---|---|---|---|---|---|---|---|---|
| | | Droplet adjusting | | | compound | | | | |
| | | agent | | Pigment | | 4EO | 3EO | | |
| | | | amount | dispersion | PEGDA | modified | modified | Photo- | Photo- |
| | | | (parts | composition | (parts | PETA | TMPTA | polymerization | polymerization |
| | | | by | 1 (parts by | by | (parts by | (parts by | initiator | inhibitor |
| | | Type | mass) | mass) | mass) | mass) | mass) | (parts by mass) | (parts by mass) |
| Ex. | Ink 1 | Compound 1 | 0.6 | 10.0 | 39.3 | 25.0 | 14.0 | 6.0 | 0.1 |
| Ex. | Ink 2 | Compound 2 | 0.6 | ↑ | ↑ | ↑ | ↑ | ↑ | ↑ |
| Ex. | Ink 3 | Compound 3 | 0.6 | ↑ | ↑ | ↑ | ↑ | ↑ | ↑ |
| Ex. | Ink 4 | Compound 4 | 0.6 | ↑ | ↑ | ↑ | ↑ | ↑ | ↑ |
| Ex. | Ink 5 | Compound 5 | 0.6 | ↑ | ↑ | ↑ | ↑ | ↑ | ↑ |
| Ex. | Ink 6 | Compound 6 | 0.6 | ↑ | ↑ | ↑ | ↑ | ↑ | ↑ |
| Ex. | Ink 7 | Compound 7 | 0.6 | ↑ | ↑ | ↑ | ↑ | ↑ | ↑ |
| Ex. | Ink 8 | Compound 8 | 0.6 | ↑ | ↑ | ↑ | ↑ | ↑ | ↑ |
| Ex. | Ink 9 | Compound 9 | 0.6 | ↑ | ↑ | ↑ | ↑ | ↑ | ↑ |
| Ex. | Ink 10 | Compound | 0.6 | ↑ | ↑ | ↑ | ↑ | ↑ | ↑ |
| | | 10 | | | | | | | |
| Ex. | Ink 11 | Compound | 0.6 | ↑ | ↑ | ↑ | ↑ | ↑ | ↑ |
| | | 11 | | | | | | | |
| Ex. | Ink 12 | Compound | 0.6 | ↑ | ↑ | ↑ | ↑ | ↑ | ↑ |
| | | 12 | | | | | | | |
| Ex. | Ink 13 | Compound | 0.6 | ↑ | ↑ | ↑ | ↑ | ↑ | ↑ |
| | | 13 | | | | | | | |
| Ex. | Ink 14 | Compound 1 | 4.0 | ↑ | 35.9 | ↑ | ↑ | ↑ | ↑ |
| Ex. | Ink 15 | Compound 1 | 0.05 | ↑ | 39.85 | ↑ | ↑ | ↑ | ↑ |
| Ex. | Ink 16 | Compound 1 | 6.0 | ↑ | 39.3 | ↑ | ↑ | ↑ | ↑ |
| Ex. | Ink 17 | Compound 1 | 0.6 | ↑ | 39.9 | ↑ | ↑ | ↑ | ↑ |
| Ex. | Ink 18 | Compound 2 | 0.6 | ↑ | ↑ | ↑ | ↑ | ↑ | ↑ |
| Comp. | Ink 19 | Compound | 0.6 | ↑ | 39.3 | ↑ | ↑ | ↑ | ↑ |
| Ex. | | 14 | | | | | | | |
| Comp. | Ink 20 | Compound | 0.6 | ↑ | ↑ | ↑ | ↑ | ↑ | ↑ |
| Ex. | | 15 | | | | | | | |

| | | | | | Proportion | | |
|---|---|---|---|---|---|---|---|
| | | | | | of the | | |
| | | | | | compound | | |
| | | Gelling agent | | Photo- | represented | | |
| | | | Amount | polymerizable | by | Evaluation | |
| | | | (parts | compound | Formula 1 | | Post- |
| | | | by | proportion | (% by | Satellite/ | processability |
| | | Type | mass) | (% by mass) | mass) | mist | of image |
| Ex. | Ink 1 | AMREPS | 5.0 | >70 | 0.6 | ⊚ | ⊚ |
| | | PC | | | | | |
| Ex. | Ink 2 | ↑ | ↑ | >70 | 0.6 | ⊚ | ⊚ |
| Ex. | Ink 3 | ↑ | ↑ | >70 | 0.6 | ⊚ | ⊚ |
| Ex. | Ink 4 | ↑ | ↑ | >70 | 0.6 | ⊚ | ⊚ |
| Ex. | Ink 5 | ↑ | ↑ | >70 | 0.6 | ⊚ | ∘ |
| Ex. | Ink 6 | ↑ | ↑ | >70 | 0.6 | ⊚ | ∘ |
| Ex. | Ink 7 | ↑ | ↑ | >70 | 0.6 | ∘ | ⊚ |
| Ex. | Ink 8 | ↑ | ↑ | >70 | 0.6 | ∘ | ∘ |
| Ex. | Ink 9 | ↑ | ↑ | >70 | 0.6 | ∘ | ⊚ |
| Ex. | Ink 10 | ↑ | ↑ | >70 | 0.6 | ∘ | ∘ |
| Ex. | Ink 11 | ↑ | ↑ | >70 | 0.6 | ∘ | ∘ |
| Ex. | Ink 12 | ↑ | ↑ | >70 | 0.6 | Δ | ∘ |
| Ex. | Ink 13 | ↑ | ↑ | >70 | 0.6 | ∘ | Δ |
| Ex. | Ink 14 | ↑ | ↑ | >70 | 4.0 | ∘ | ∘ |
| Ex. | Ink 15 | ↑ | ↑ | >70 | 0.05 | ∘ | Δ |
| Ex. | Ink 16 | | | >70 | 6.0 | ∘ | Δ |
| Ex. | Ink 17 | — | — | >70 | 0.6 | ∘ | Δ |
| Ex. | Ink 18 | — | — | >70 | 0.6 | ∘ | Δ |
| Comp. | Ink 19 | AMREPS | 5.0 | >70 | — | x | x |
| Ex. | | PC | | | | | |
| Comp. | Ink 20 | ↑ | ↑ | >70 | — | x | x |
| Ex. | | | | | | | |

As shown in Table 1 above, according to the inks that included the droplet adjusting agents represented by the general formula (1) above and in which the amount of the photopolymerizable compound was 70% by mass or more, satellite and mist was less likely to occur (inks 1 to 18). Each ink contains a droplet adjusting agent represented by the general formula (1) described above, and thus the compound is oriented on the surface of a droplet of the inkjet ink to cover the entire droplet. As a result, it is considered that the droplet became less likely to be split, and thus satellites and mist became less likely to be generated. Further, the printed materials obtained from these ink had satisfactory post-processability. It is considered that the cured product of each ink has a large hydrophilic moiety, and a hydrophilic area is present on the surface of the cured product, and thus post-processability is improved.

On the other hand, when an ink does not include the droplet adjusting agent represented by the general formula (1), satellites and mist occurred particularly in a case where the hydrophilic moiety was small, and furthermore, the post-processability was also low (ink 19). In addition, in a case where the hydrophilic moiety was excessively large, the ejectability from inkjet nozzle tended to deteriorate, and satellites and mist were generated (ink 20). Furthermore, in this case, since the droplet became unstable, the post-processability of the cured product was also low.

### INDUSTRIAL APPLICABILITY

The present invention is capable of providing an active ray curable inkjet ink that is less likely to cause satellites and mist during printing and can form a coating film having satisfactory post-processability. The ink is very useful in printing in various industrial fields.

What is claimed is:

1. An active ray curable inkjet ink comprising a photopolymerizable compound, a photoinitiator, a pigment, and a pigment-dispersing agent, wherein
the active ray curable inkjet ink further contains a compound represented by a general formula (1) below: 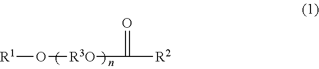
in the general formula (1),
R¹ and R² each independently represent a substituted or unsubstituted alkyl group, a substituted or unsubstituted alkoxy group, a substituted or unsubstituted alkylthio group, a substituted or unsubstituted aryl group, a substituted or unsubstituted heterocyclic group, or a combination thereof,
R³ represents a substituted or unsubstituted alkylene group having 2 or more and 6 or less carbon atoms, and
n represents an integer of 50 or more and 300 or less; and
an amount of the photopolymerizable compound is 70% by mass or more with respect to a total mass of the active ray curable inkjet ink.

2. The active ray curable inkjet ink according to claim 1, wherein
an amount of the compound represented by the general formula (1) is 0.1 mass % or more and 4.0 mass % or less with respect to the total mass of the active ray curable inkjet ink.

3. The active ray curable inkjet ink according to claim 1, wherein
the compound represented by the general formula (1) is a compound represented by a general formula (2) below: 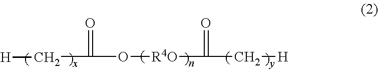
in the general formula (2),
R⁴ represents an ethylene group, a propylene group, a trimethylene group, or a tetramethylene group,
x and y each independently represent an integer of 1 or more and 30 or less, and
n represents an integer of 50 or more and 300 or less.

4. The active ray curable inkjet ink according to claim 1, wherein
the compound represented by the general formula (1) is a compound represented by a general formula (3) below: 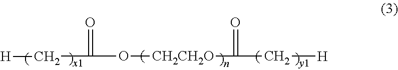
in the general formula (3),
x1 and y1 each independently represent an integer of 15 or more and 19 or less, and
n represents an integer of 170 or more and 210 or less.

5. The active ray curable inkjet ink according to claim 1, further comprising a gelling agent.

6. The active ray curable inkjet ink according to claim 5, wherein
the gelling agent contains at least one compound selected from compounds represented by general formulae (G1) and (G2) below: 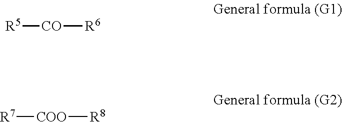
in the general formulae (G1) and (G2), R⁵ to R⁸ each independently represent a linear or branched alkyl group having 12 or more and 26 or less carbon atoms.

7. A method for producing a printed material, the method comprising:
ejecting an ink droplet of the active ray curable inkjet ink according to claim 1 from an inkjet recording head to cause the ink droplet to land on a recording medium; and
irradiating the ink droplet having landed on the recording medium with an active ray to cure the ink droplet.
